(19) United States
(12) Patent Application Publication
(10) Pub. No.: US 2009/0069134 A1
(43) Pub. Date: Mar. 12, 2009

(54) Dual idler structure for an elliptical trainer

(75) Inventor: Hai-Pin Kuo, Tainan (TW)

Correspondence Address: BACON & THOMAS, PLLC, 625 SLATERS LANE, FOURTH FLOOR, ALEXANDRIA, VA, 22314-1176, US

(73) Assignee: Sports Art Industrial Co., Ltd., Tainan (TW)

(21) Appl. No.: 11/898,391

(22) Filed: Sep. 12, 2007

(51) Int. Cl. A63B 22/04; F16H 7/12

(52) U.S. Cl. 474/134; 482/52

(57) ABSTRACT

A dual idler structure of an elliptical trainer can tighten a transmission belt, without easily causing the belt to be slipped upon rotating clockwise or counterclockwise. By operating an upper and a lower stopping bolt to abut an upper and a lower idler set, resilience to the idler sets by the transmission belt upon rotating clockwise or counterclockwise is prevented, such that the belt is prohibited from being easily slipped.

### BACKGROUND OF THE INVENTION

a) Field of the Invention

The present invention relates to a dual idler structure for an elliptical trainer, and more particularly to a dual idler structure which can tighten a transmission belt, such that the belt will not be easily slipped, by operating an upper and a lower stopping bolt to stop against an upper and a lower idler set, which is sufficient to prevent from resilience to the idler sets by pulleys upon rotating clockwise or counterclockwise, thereby prohibiting the belt from being easily slipped.

b) Description of the Prior Art

A conventional elliptical trainer is basically provided with a foot base, on which is installed with a large pulley driven by a crank shaft. A transmission belt is used to connect the large pulley and a small pulley, the small pulley is basically connected to a load wheel coaxially, and a user steps on pedals with two feet, allowing the crank shaft to drive the large pulley to rotate. This kind of elliptical trainer provides the user to step forward for exercise, which means that the large pulley can only rotate along one direction, e.g., clockwise. The other function that the elliptical trainer provides is that if the user steps backward for exercise, then the large pulley must rotate counterclockwise. However, when this kind of pulley, which rotates clockwise or counterclockwise, changes the direction of rotation, the transmission belt will be easily slipped, which will cause a pause to the user.

### SUMMARY OF THE INVENTION

Accordingly, the primary object of the present invention is to provide a dual idler structure for an elliptical trainer to prevent from resilience to idler sets caused by pulleys while they are rotating clockwise or counterclockwise, thereby prohibiting the belt from being easily slipped.

Another object of the present invention is to provide a dual idler structure for an elliptical trainer which operates an upper and a lower stopping bolt to stop against an upper and a lower idler set, to sufficiently prevent from resilience to the idler sets caused by pulleys while rotating clockwise or counterclockwise, thereby prohibiting the belt from being easily slipped.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a side view of the present invention.

FIG. 2 shows an exploded view of an upper idler set of the present invention.

### DETAILED DESCRIPTION OF THE PREFERRED EMBODIMENTS

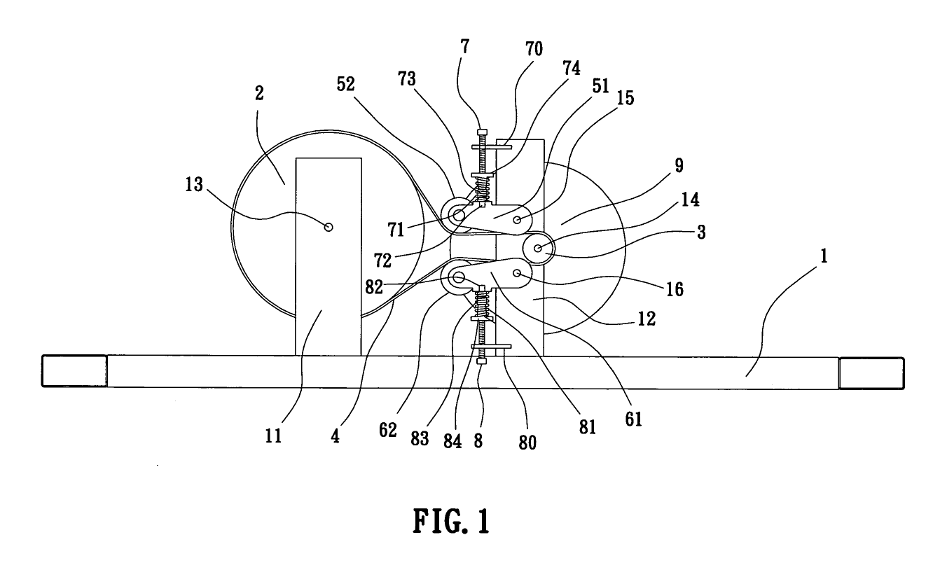

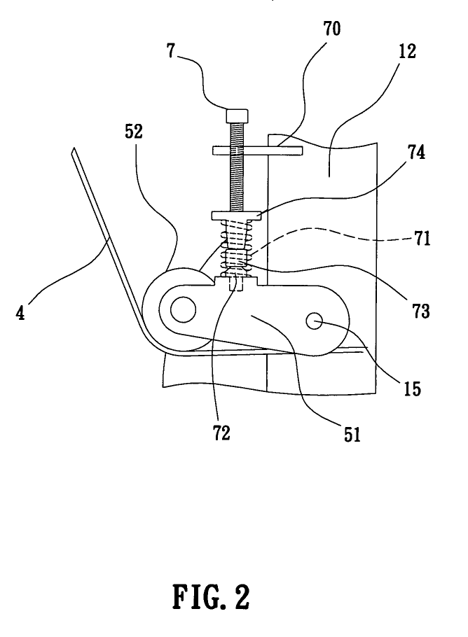

Referring to FIG. 1 and FIG. 2, an elliptical trainer of the present invention includes basically a foot base 1 on which is provided with two separate posts 11, 12. The post 11 is provided with a pivot 13 which provides a pivoting point for connection with a crank, and an end of the pivot 13 is fixed with a large pulley 2. Two sides of the post 12 are fixed at a same time with a small pulley 3 and a load wheel 9 by a pivot 14, whereas a transmission belt 4 is connected on the aforementioned large pulley 2 and small pulley 3.

Each of an upper and a lower idler set, both of which are provided with exactly the same structures, includes an upper and a lower control bolt 7, 8, an upper and a lower tie plate 51, 61, springs 71, 81, bosses 72, 82, shock-proof elements 73, 83, and tie seats 74, 84. The aforementioned upper and lower tie plates 51, 61 are movably installed on the post 12 with pivots 15, 16, and the upper and lower idlers 52, 62 are abutted at a same time on external surfaces of the aforementioned transmission belt 4. The upper and lower control bolts 7, 8 are screwed on positioning pieces 70, 80 which are installed on the post 12. The bosses 72, 82 are put up on the aforementioned upper and lower tie plates 51, 61; bottoms of the springs 71, 81 are sheathed at outer circumferences of the aforementioned bosses 72, 82; the shock-proof elements 73, 83 are emplaced inside the springs 71, 81, and are abutted on the aforementioned bosses 72, 82; an end of each one of the tie seats 74, 84 is also emplaced inside each one of the springs 71, 81, whereas the other end of each one of the tie seats 74, 84 is exposed out of a tail end of each one of the springs 71, 81. Each of the aforementioned upper and lower control bolts 7, 8 is positioned on a tail end of a side of each one of the positioning pieces 70, 80, and can be abutted at an aperture of each one of the tie seats 74, 84.

When the large pulley 2 rotates counterclockwise, the transmission belt 4 above the pivots 13, 14 will be tightened; whereas, the transmission belt 4 below the pivots 13, 14 will be loosened. On the contrary, when the large pulley 2 rotates clockwise, the transmission belt below the pivots 13, 14 will be tightened, and the transmission belt 4 above the pivots 13, 14 will be loosened. By using the upper and lower idler sets, the transmission belt 4 will be tightened under a normal condition of usage, and the transmission belt 4 will not be slipped when the large pulley 2 changes direction of rotation. To be more specific, by using the upper and lower control bolts 7, 8 to completely tighten and position the upper and lower tie plates 51, 61, the tie plates 51, 61 will be resiled by action force exerted by the transmission belt 4, which means that it is not easy to result in a slipping phenomenon from an abutting between the transmission belt 4 and the upper and lower idlers 52, 62.

During a period of usage, the transmission belt 4 will be elastically fatigued. To overcome this phenomenon and to allow the upper and lower idlers 52, 62 to more accurately tighten the transmission belt 4, a user can tune compression of the springs 71, 81 by adjusting the control bolts 7, 8, which will enable the upper and lower idlers 52, 62 to tightly press on the transmission belt 4, so as to prevent from the resilience to the upper and lower idlers 52, 62 when the belt is rotating clockwise or counterclockwise, thereby prohibiting the belt from being easily slipped. On the other hand, by locating the shock-proof elements 73, 83 between the tie seats 74, 84 and the bosses 72, 82, resilience force generated by the upper and lower tie plates 51, 61, due to force exerted by the transmission belt 4, can be removed. This will further prohibit the transmission belt 4 from being easily slipped. The shock-proof elements 73, 83 can be definitely made by chemical rubber or plastic.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A dual idler structure for an elliptical trainer, with the elliptical trainer comprising a foot base on which is provided with two separate posts; one post having a pivot which provides a pivoting point for connection with a crank, and an end of which is fixed with a large pulley; two sides of the other posit being fixed at a same time with a small pulley and a load wheel by a pivot; and a transmission belt being connected between the aforementioned large pulley and small pulley; the foot base being provided with an upper and a lower idler set having exactly the same structures, with the upper and lower idler sets including an upper and a lower control bolt, an upper and a lower tie plate, springs, bosses, shock-proof elements, and tie seats; the aforementioned upper and lower tie plates being movably fixed on the post with a pivot, and the upper and lower idlers being abutted at a same time on external surfaces of the aforementioned transmission belt; the upper and lower control bolts being screwed on positioning pieces which are installed on the post; the bosses being put up on the aforementioned upper and lower tie plates, with a bottom of each one of the springs being sheathed on an outer circumference of each one of the aforementioned bosses; each one of the shock-proof elements being emplaced inside each one of the springs and abutted on each one of the aforementioned boss, an end of each one of the tie seats being emplaced inside each one of the springs and abutted on each one of the shock-proof elements, and the other end of each one of the tie seats being exposed out of a tail end of each one of the springs; each one of the aforementioned upper and lower control bolts being positioned at a tail end of a side of each one of the positioning pieces, and abutted on an aperture on each one of the tie seats; accordingly, resilience to the upper and lower idler sets by the transmission belt upon rotating clockwise or counterclockwise being prevented, thereby prohibiting the transmission belt from being easily slipped.

2. The dual idler structure for an elliptical trainer according to claim 1, wherein the shock-proof elements are made by chemical rubber or plastic.
